(19) United States
(12) Patent Application Publication
(10) Pub. No.: US 2008/0104871 A1
(43) Pub. Date: May 8, 2008

(54) Variable message sign control system

(75) Inventor: Robert Charles Stadjuhar, Woodland Park, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Skyline Products, Inc.

(21) Appl. No.: 11/593,277

(22) Filed: Nov. 6, 2006

(51) Int. Cl. G09F 7/00

(52) U.S. Cl. 40/584

(57) ABSTRACT

A variable message sign control system has a number of variable message signs. The variable messages signs are coupled by local communication links to a sign controller. This single sign controller takes the place of multiple sign controllers in previous designs.

### RELATED APPLICATIONS

None.

### FIELD OF THE INVENTION

The present invention relates generally to the field of variable message signs and more particularly to a variable message sign control system.

### BACKGROUND OF THE INVENTION

Variable message signs are used on roadways to inform motorists of hazards and traffic conditions. Each variable message sign has a controller that has a direct communication link to a central office or central controller. Often the direct communication link is a fiber optic link, which is expensive to install and requires an expensive fiber modem. In addition, the direct communication link requires an overhead intensive communication protocol such as NTCIP (National Transportation Communication for ITS [Intelligent Transportation Systems] Protocol). In addition, each of these direct communication links and its associated hardware are potential failure points as is each of the controllers.

Thus, there exists a need for a sign controller system that is less expensive to install and operate and increases the reliability for variable message signs.

### SUMMARY OF THE INVENTION

A variable message sign control system that overcomes these and other problems includes a plurality of variable message signs. The plurality of variable messages signs are coupled by local communication links to a sign controller. This single sign controller takes the place of multiple sign controllers in previous designs. The local communication links use low cost, overhead efficient protocols and physical layers such as wireless Ethernet protocols. The single sign controller has a single communication link to the central office. This reduces the cost and overhead compared to the multiple sign controllers and further reduces the cost compared to multiple separate ground or pole mounted control cabinets.

### BRIEF DESCRIPTION OF THE DRAWINGS

FIG. 1 is a diagram of a variable message sign control system in a typical freeway setting in accordance with one embodiment of the invention; and

FIG. 2 is a block diagram of a variable message sign control system in accordance with one embodiment of the invention.

### DETAILED DESCRIPTION OF THE DRAWINGS

The invention is a variable message sign control system that includes a plurality of variable message signs. The plurality of variable messages signs are coupled by local communication links to a sign controller. This single sign controller takes the place of multiple sign controllers in previous designs. The local communication links use low cost, overhead efficient protocols and physical layers such as wireless Ethernet protocols. The single sign controller has a single communication link to the central office. This reduces the cost and overhead compared to the multiple sign controllers. The communication link to the central office may also have two communication links. One of these links may be a backup link.

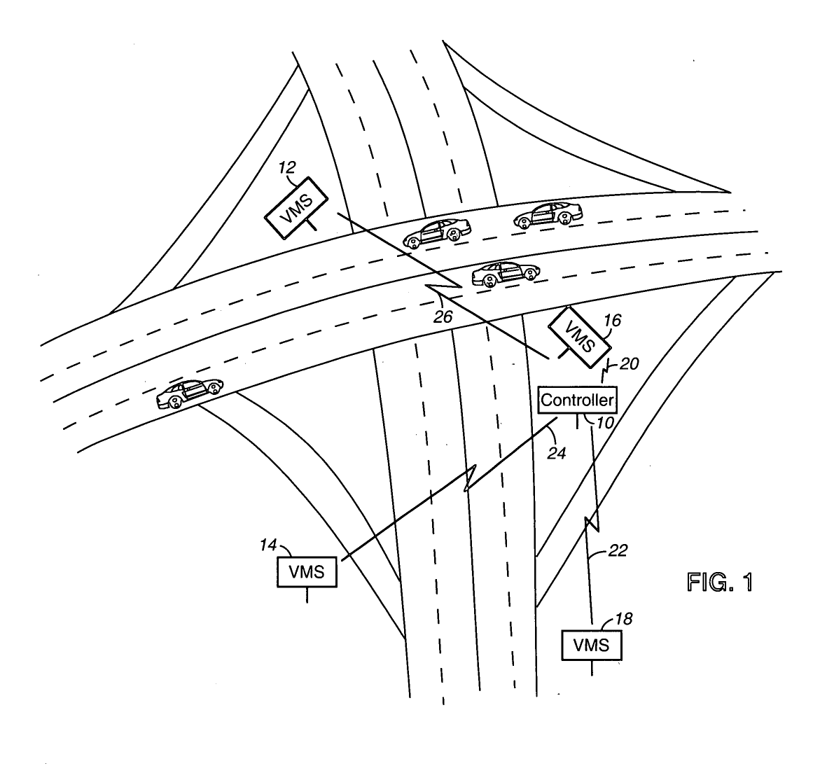

FIG. 1 is a diagram of a variable message sign control system in a typical freeway setting in accordance with one embodiment of the invention. The variable message sign control system has a sign controller 10. The sign controller 10 is commonly placed either in one of the plurality of variable message signs (VMS) 12, 14, 16, 18 or in a pole or ground mounted enclosure. The sign controller 10 has a number of local communication links 20, 22, 24, 26 that allow the sign controller 10 to communicate with each of the variable message signs (VMS) 12, 14, 16, 18. The local communication links 20, 22, 24, 26 may be wireless links, such as wireless Ethernet, or may be wired communication links. The variable message signs (VMS) 12, 14, 16, 18 display information about hazard or traffic conditions commonly for interstates or freeways. For instance, a variable message sign may display a message that there is an accident ahead or that the commute time though downtown is thirty minutes. These variable message signs are not standard three color traffic lights.

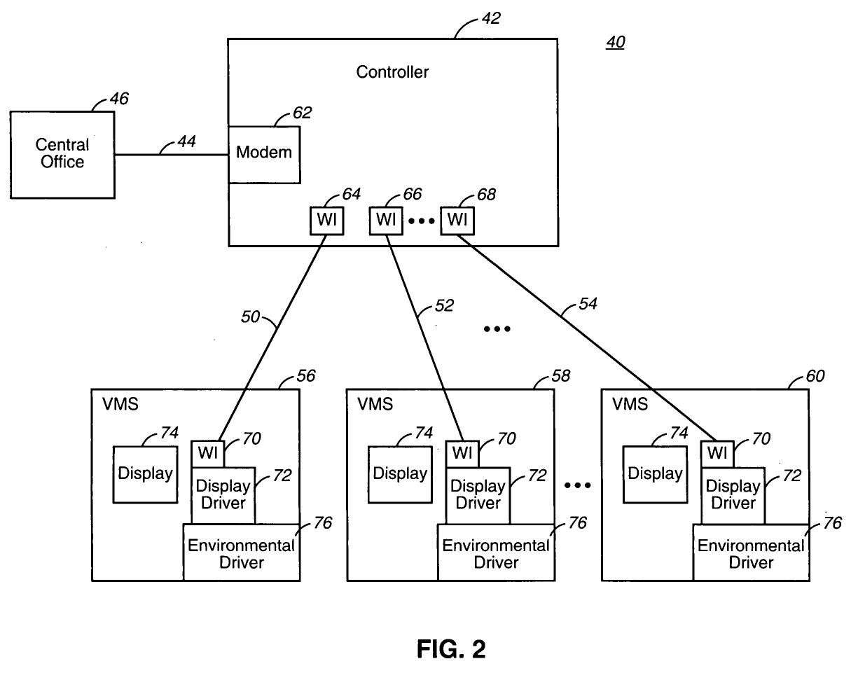

FIG. 2 is a block diagram of a variable message sign control system 40 in accordance with one embodiment of the invention. The system 40 has sign controller 42. The sign controller 42 has a communication link, central office communication link 44, with the central office 46. In addition, the sign controller 42 has a plurality of local communication links 50, 52, 54 that connect the sign controller 42 to a plurality of variable message signs (VMS) 56, 58, 60. The sign controller 42 has a modem 62 for communication over the central office communication link 44. In one embodiment, the central office communication link 44 is a fiber optic link and the modem 62 is a fiber optic modem. In another embodiment, the communication protocol for the central office communication link 44 is NTCIP (National Transportation Communication for ITS [Intelligent Transportation Systems] Protocol). The sign controller 42 also has a plurality of local interfaces (WI) 64, 66, 68 for communicating over the local communication links 50, 52, 54. In one embodiment, these local communication links 50, 52, 54 are wireless communication links, however wired communication links are also contemplated. Ideally, the communication protocol used is any of a number of overhead efficient communication protocols. However, the invention certainly encompasses communication protocols such as NTCIP.

The variable message signs 56, 58, 60 all have a communication interface (WI) 70. A display driver 72 of the variable message signs 56, 58, 60 controls the display 74. Each variable message signs 56, 58, 60 also has an environmental driver 76. Note that a sign driver includes a display driver 72 and an environmental driver 76.

In operation the central office 46 determines the message each variable message sign 56, 58, 60 should display. This information is transmitted over the central office communication link 44 to the sign controller 42. The sign controller 42 schedules each message for display on the appropriate variable message sign 56, 58 60. The message to be displayed is transmitted from the sign controller 42 to the appropriate variable message sign 56, 58 60 over a local communication link 50, 52, 54. The display driver 72 then drives the display 74. The display driver 72 determines a brightness of each display element based on a number factors including the ambient light. The display driver 72 reads the display output, by determining an amount of power each display element is consuming. A picture or representation of the displayed message is transmitted to the sign controller 42. This information is forwarded to the central office 46. The environmental drivers 76 monitor a number of environmental conditions including: internal temperature of the sign; external temperature; humidity; ventilation air flow amounts; power supply status, etc. These measurements are used to construct an environmental status message that is transmitted to the sign controller 42. The sign controller 42 forwards the environmental message to the central office. In addition, the environmental driver 76 may turn on or off a fan, or advance a filter material based on these measurements.

This system 40 eliminates the need for multiple sign controllers, multiple expensive communication links to the central office and reduces the number of potential failure points. It also eliminates multiple ground or pole mounted cabinets if the sign controller is not located in the sign. Thus there has been described a variable message sign control system that is less expensive to install and operate and increases the reliability for variable message signs.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A variable message sign control system, comprising:
a sign controller;
a plurality of variable message signs receiving a message for display from the sign controller.

2. The system of claim 1, further including a plurality of wireless communication links between the sign controller and the plurality of variable message signs.

3. The system of claim 1, wherein each of the plurality of variable message signs has a sign driver.

4. The system of claim 3, wherein the sign driver includes a display driver and an environmental driver.

5. The system of claim 1, wherein the sign controller has a central controller communication link.

6. The system of claim 5, wherein the sign controller polls each of the variable message signs for status information.

7. The system of claim 6, wherein the sign control transmits the status information to a central controller.

8. The system of claim 7, wherein the status information includes display status.

9. The system of claim 7, wherein the status information includes environmental status.

10. A variable message sign control system, comprising:
a plurality of variable message signs;
a sign controller; and
a plurality of local communication links connecting the plurality of variable message signs to the sign controller.

11. The system of claim 10, wherein each of the plurality of variable message signs has a sign driver.

12. The system of claim 11, wherein the driver includes a display driver and an environmental driver.

13. The system of claim 10, wherein the plurality of local communication links is a wireless communication link.

14. The system of claim 10, wherein the sign controller polls each of the plurality of variable message signs for status information.

15. The system of claim 10, wherein the sign controller includes a central office communication link.

16. The system of claim 15, wherein the sign controller transmits the status information over the central office communication link to a central office.

17. The system of claim 16, wherein each of the plurality of variable message signs has a display driver that reads the display output.

18. A variable message sign control system, comprising:
a plurality of variable message signs; and
a sign controller receiving a status report from the plurality of variable message signs.

19. The system of claim 18, further including plurality of local communication links between the sign controller and the plurality of variable message signs.

20. The system of claim 19, wherein the plurality of communication links are wireless.

21. The system of claim 18, wherein each of the variable message signs has a sign driver.

22. The system of claim 21, wherein the sign driver includes a display driver and an environmental driver.

23. The system of claim 21, wherein the display driver transmits the status report over one of the plurality of communication links.

24. The system of claim 18, wherein the sign controller has a central office communication link.

25. The system of claim 24, wherein the sign controller transmits the status report over the central office communication link to a central office.
